(19) United States
(12) Patent Application Publication
(10) Pub. No.: US 2008/0025275 A1
(43) Pub. Date: Jan. 31, 2008

(54) Wireless local area network and method thereof

(76) Inventors: Jian Gang Cheng, Beijing (CN); Teh-Chao Chang Hsu, Beijing (CN); Guang Xuan Liu, Beijing (CN); Jun Wang, Shanghai (CN); Rong Qiang Zhang, Beijing (CN)

Correspondence Address: HARNESS, DICKEY & PIERCE, P.L.C., P.O. BOX 8910, RESTON, VA, 20195, US

(21) Appl. No.: 11/642,919

(22) Filed: Dec. 21, 2006

(30) Foreign Application Priority Data
Jul. 27, 2006 (CN) 200610108068.7

(51) Int. Cl. H04Q 7/24

(52) U.S. Cl. 370/338

(57) ABSTRACT

The example method is directed to managing access points in a wireless local area network (WLAN) operating in accordance with a wireless communication protocol. The example method includes managing which of a plurality of access points in the wireless local area network handles communication with a wireless station, where each of the plurality of access points are assigned a same communication frequency range and same identifying information for communication with wireless stations. The example WLAN is directed to a WLAN operating in accordance with a wireless communication protocol including a plurality of access points. The plurality of access points are configured to support communication with wireless stations. Each of the plurality of access points are assigned a same communication frequency range and same identifying information for communication with the wireless stations. The example WLAN further includes a master controller managing which of the plurality of access points in the wireless local area network handles communication with a wireless station.

### PRIORITY STATEMENT

This application claims priority under 35 U.S.C. § 119 to Chinese Patent Application No. 200610108068.7, filed on Jul. 27, 2006, in the Chinese Patent Office (CPO), the disclosure of which is incorporated herein in its entirety by reference.

### BACKGROUND OF THE INVENTION

1. Field of the Invention

Example embodiments of the present invention are related generally to a wireless communication system and method thereof, and more particularly to a wireless local area networks (WLAN) and method thereof.

2. Description Of The Related Art

In WLANs, mobile devices use access points (APs) (e.g., a wireless router) to connect to wired networks and communicate with other hosts. An AP is typically equipped with an interface that connects to a wired network (e.g., via an Ethernet connection) and a wireless interface (e.g., IEEE 802.11 b/g) 802.16 (d/e), Bluetooth, etc.) that communicates with mobile devices.

A coverage area of an AP operating indoors in accordance with 802.11 is limited to approximately 200 to 300 feet. Additional APs may be used to expand the coverage area. When a mobile device moves from the coverage area of a first AP to a second AP, the handling of the mobile device's communications has to be “handed off” from the first AP to the second AP. In 802.11b, handoffs are initiated by the mobile device and occur at either layer-2 or layer-3 of a protocol stack.

For example, if the first and second APs function as MAC layer (layer-2) bridges, the handoff is performed only at layer-2 because both the first and second APs belong to the same IP subnet. In an alternative example, if the first and second APs function as IP (layer-3) routers, the first and second APs belong to different IP subnets. Thus, in addition to a layer-2 handoff, a layer-3 handoff is also necessary.

In WLANs intended for large coverage areas, seamless roaming support for mobile devices within the network is a desirable design criteria. In other words, ensuring mobility of mobile devices throughout the WLAN coverage area without any service disruptions is desired. Thus, transport and application level sessions should not be disrupted during handoffs between APs. Real-time applications (e.g., VOIP, streaming audio and/or video, etc.) require that handoffs (e.g., layer-2 and/or layer-3 handoffs) be performed fast enough to avoid service disruption. For example, disruptions in a VOIP call would be noticed if the “jitter” is above a time threshold (e.g., 50 milliseconds (ms)). Thus, to support VOIP in 802.11 WLANs and avoid service disruption (e.g., jitter), handoffs must be performed in less time than the jitter time threshold.

Conventional mobile devices within 802.11 WLAN networks perform layer-2 handoffs in accordance with a break-before-make approach, alternatively referred to as “hard handoff”. In a hard handoff, a radio card (e.g., a PCMCIA wireless 802.11b card, etc.) on the mobile device begins probing for available neighboring APs with acceptable signal strengths if a signal strength of the connection with the serving AP drops below a signal strength threshold. In an example, 802.11b WLANs include 11 channels which may be probed for available APs, where a probing of all 11 channels may take up to a second to complete. Once an acceptable AP is discovered through the probing step, the mobile device authenticates with the new AP and then associates with the new AP by performing a layer-2 association. While still significant, delays associated with the associating and authenticating steps (e.g., 10 ms) are typically less than delays associated with the probing step (e.g., up to 1 second).

APs in conventional WLANs each transmit on one of a plurality of channels (e.g., 11 channels in 802.11b), with neighboring APs typically transmitting on different channels to reduce outer-cell interference (e.g., interference received at a local AP from a neighbor AP or mobile devices served by a neighbor AP). APs in conventional WLANs also typically have different machine access code (MAC) addresses and different basic service set identifiers (BSSIDs), so the mobile device can distinguish between different APs (e.g., to select a new AP to connect to, etc.). In conventional WLANs, it is important for each mobile device to be able to distinguish between neighboring APs in order to select a new AP to handoff to (i.e., “hard” handoff) if a connection with a currently serving AP drops below a connection strength threshold (e.g., a signal strength level below which a connection cannot be maintained).

The above-described probing, authenticating and associating steps may take a substantial amount of time (e.g., hundreds of milliseconds) which may vary based in part on the type of radio card being used. Further, if required, layer-3 handoffs add additional handoff latencies (e.g., on the order of hundreds of milliseconds). The delays associated with layer-2 and layer-3 handoffs are often large enough to cause service disruption in real-time applications in 802.11 WLANs.

A conventional method of reducing the above-described probing delays includes reporting the presence of neighboring APs to each mobile device in the coverage area of a 802.11 WLAN. Thus, since particular APs are “static” and typically remain on the same channel, the probing step may be limited to channels associated with the APs reported to the mobile device. However, the above-described conventional AP reporting method requires maintenance and dissemination of information to the mobile devices in the coverage area, and further requires changes to 802.11 protocols and an active management of the AP reports. Also, even if the delays associated with probing are reduced, delays associated with authentication and association still remain.

### SUMMARY OF THE INVENTION

An example embodiment of the present invention is directed to a method of managing access points in a wireless local area network (WLAN) operating in accordance with a wireless communication protocol. The example embodiment includes managing which of a plurality of access points in the wireless local area network handles communication with a wireless station, where each of the plurality of access points are assigned a same communication frequency range and same identifying information for communication with wireless stations.

Another example embodiment of the present invention is directed to a WLAN operating in accordance with a wireless communication protocol. This example embodiment includes a plurality of access points configured to communicate with wireless stations. Each of the plurality of access points are assigned a same communication frequency range and same identifying information for communication with wireless stations. A master controller manages which of the plurality of access points in the wireless local area network handles communication with a wireless station.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a wireless local area network (WLAN) according to an example embodiment of the present invention.

FIG. 2 illustrates a coverage area of an access point including a mobile device within the WLAN of FIG. 1 according to an example embodiment of the present invention.

FIG. 3 illustrates a call setup process for the mobile device performed at the access point of FIG. 2 according to an example embodiment of the present invention.

FIG. 4 illustrates a handoff process of a mobile device from a first access point to a second access point within the WLAN of FIG. 1 according to an example embodiment of the present invention.

FIG. 5 illustrates positions of the mobile device within the WLAN of FIG. 1 during different steps of the handoff process of FIG. 4.

FIG. 6 illustrates a portion of the WLAN system of FIG. 1 including a first access point, a second access point and a plurality of mobile devices according to another example embodiment of the present invention.

### DETAILED DESCRIPTION OF EXAMPLE EMBODIMENTS

In order to better understand the present invention, a description of a wireless local area network (WLAN) according to an example embodiment of the present invention is provided. Then, a call setup is described with respect to the example WLAN, followed by a handoff process performed within the example WLAN.

### Wireless Local Area Network (WLAN) System

As discussed in the Background of the Invention section, APs in conventional WLANs each transmit on one of a plurality of channels or frequency ranges, with neighboring APs typically transmitting on different channels to reduce outer-cell interference, or interference received at a local AP from a neighboring cell (e.g., from a neighbor AP and/or mobile devices being served by a neighbor AP). APs in conventional WLANs also typically have different machine access code (MAC) addresses and different basic service set identifiers (BSSIDs). As will now be described in greater detail, WLANs according to example embodiments of the present invention include APs which communicate over the same channel (e.g., the same frequency range) and with the same MAC address and BSSID such that, from the perspective of a mobile device within the WLAN, all of the APs are the same.

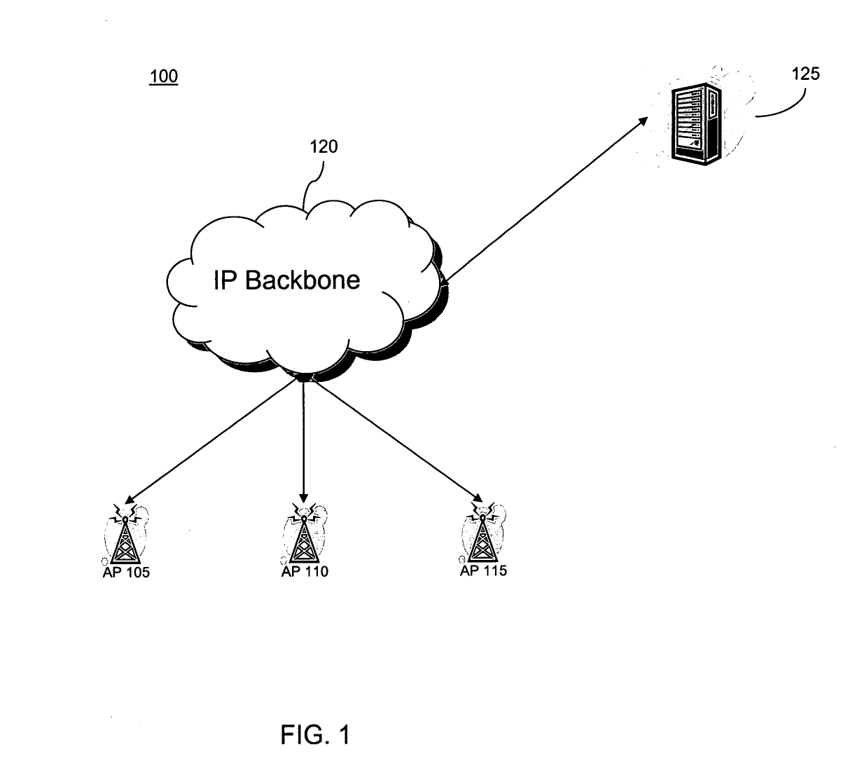

FIG. 1 illustrates a wireless local area network (WLAN) 100 according to an example embodiment of the present invention. In the example embodiment of FIG. 1, the WLAN 100 includes access points (APs) 105, 110 and 115, an internet protocol (IP) backbone 120 and a master controller (MC) 125. The APs 105/110/115 have overlapping coverage areas to reduce “gaps” in services provided to mobile devices (not shown). The APs 105/110/115 provide services to mobile devices within their respective coverage area over a wireless or air interface with any well-known wireless communication protocol, such as 802.11(a/b/g), 802.16e, Bluetooth, etc. The APs 105/110/115 are each further connected to the IP Backbone 120 over a wired connection or interface. The IP Backbone 120 is a switch that connects the WLAN 100 to an edge router, through which the WLAN 100 is connected to the Internet. The IP Backbone 120 is connected to the master controller 125 over a wired connection or interface.

The APs 105, 110 and 115 each communicate on the same channel (i.e., frequency range or bandwidth) and are assigned the same MAC address and the same BSSID. As will now be described, the uniformity of the APs 105, 110 and 115 within the WLAN 100 allows handoff support to be “offloaded” from mobile devices being served by the APs 105/110/115 to the master controller 125.

### Call Setup within the WLAN System

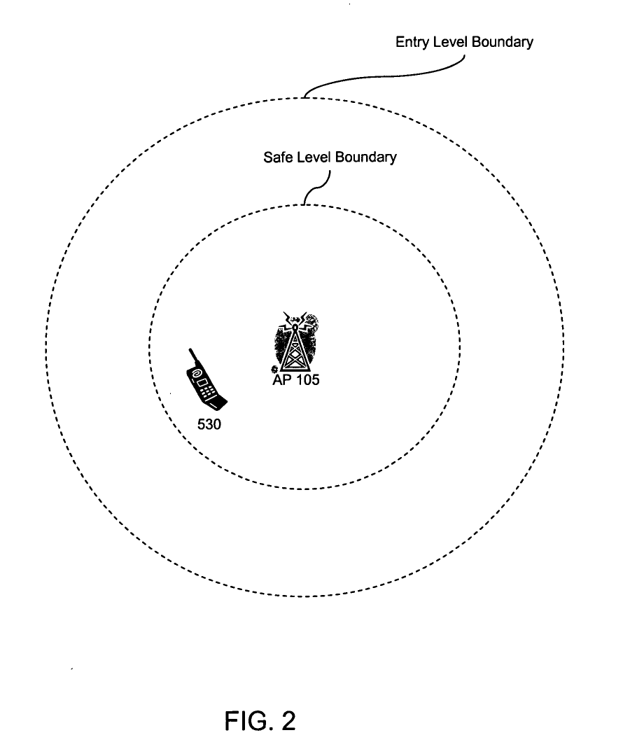

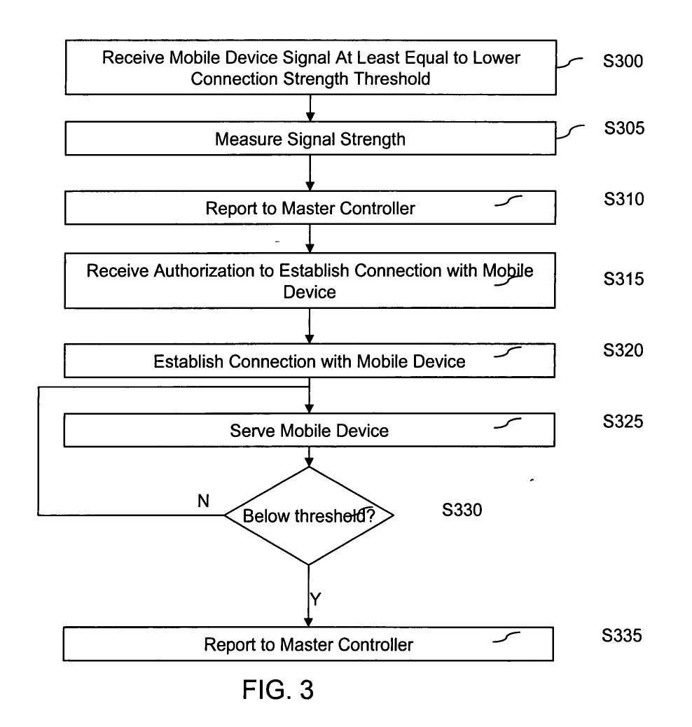

An example of call setup will now be described with reference to FIGS. 2 and 3 and the WLAN system 100 of FIG. 1.

FIG. 2 illustrates a coverage area of AP 105 including a mobile device 530 according to an example embodiment of the present invention. The coverage area of AP 105 includes a first coverage area bounded by an entry level boundary and a second coverage area bounded by a safe level boundary. Hereinafter, the first coverage area shall be referred to as an “entry level boundary region” and the second coverage area shall be referred to as a “safe level boundary region”.

In order to facilitate handoffs of mobile devices (e.g., mobile device 530) from a first AP (e.g., AP 105) to a second AP (e.g., AP 110) within the WLAN 100, the MC 125 defines a lower connection strength threshold and a higher connection strength threshold for each AP within the WLAN 100. Referring to FIG. 2, mobile devices being served by the AP 105 and positioned further away from the AP 105 generally have lower connection strengths than mobile devices positioned closer to the AP 105.

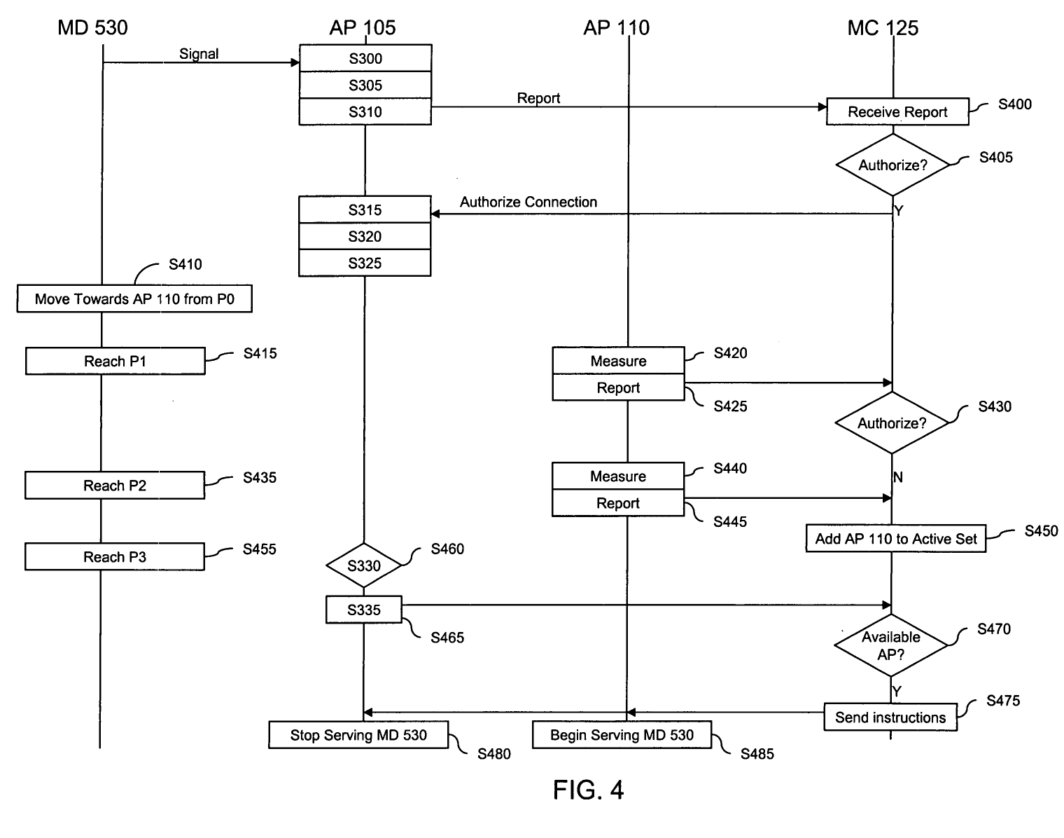

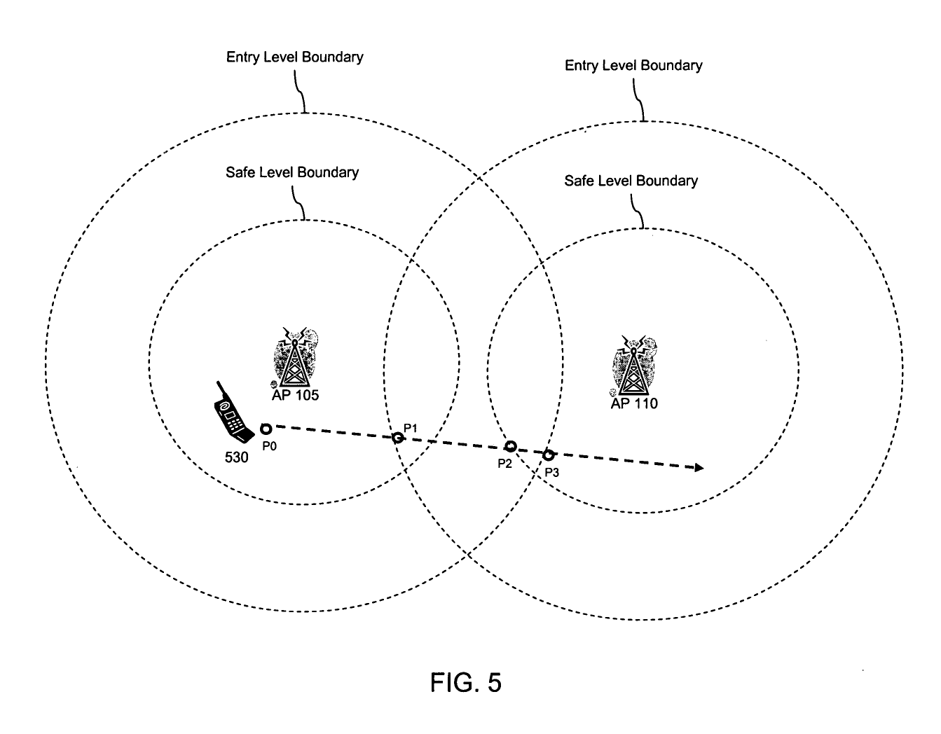

As shown in FIG. 2, the entry level boundary region includes mobile devices 530 with connection strengths above the lower connection strength threshold and the safe level boundary region includes mobile devices 530 with connection strengths above the higher connection strength threshold. The safe level boundary region is not used during call setup, and will be discussed in greater detail later with respect to call handoff and FIGS. 4 and 5.

In the example embodiment of FIG. 2, the mobile device 530 may be any well-known mobile device, including but not limited to a personal computer (PC), a notebook or laptop computer, a cellular phone, a PDA, a video game unit (e.g., a Playstation portable (PSP), a Nintendo DS, etc.), and/or any other well-known device capable of wireless communication.

FIG. 3 illustrates a call setup process for the mobile device 530 performed at AP 105 according to an example embodiment of the present invention. The call setup process of FIG. 3 will hereinafter be described with reference to FIG. 2. Within the process of FIG. 3, it is assumed that the mobile device 530 is new to the WLAN 100. In other words, the mobile device 530 is not being served by any AP other than AP 105 within the WLAN 100 during the process of FIG. 3.

In step S300 of FIG. 3, the AP 105 receives a signal from the mobile device 530. For example, the signal may be a mobile pilot signal, a request for services, etc. The AP 105 measures the signal strength of the received signal in step S305. In step S310, if the measured signal strength is greater than or equal to the lower connection strength threshold, the AP 105 sends a report to the MC 125 indicating that the mobile device has a signal strength at least equal to the lower connection strength threshold.

As discussed above, within the process of FIG. 3, it is assumed that the mobile device 530 requesting service in step S300 is not being served by any AP other than AP 105 within the WLAN 100 during the process of FIG. 3. Accordingly, in step S315 the AP 105 receives instructions from the MC 125 authorizing the AP 105 to establish a connection with the mobile device. The AP 105 establishes a connection with the mobile device 530 in step S320 according to conventional methods. As discussed in the Background of the Invention section, call setup typically includes probing, association and authentication. In step S320, probing is not necessary because the AP 105 is already monitoring signals from the mobile device 530. Thus, the AP 105 associates and authenticates the mobile device 530. Thereafter, in step S325, the AP 105 serves the mobile device 530 and continues to monitor the mobile device's 530 signal strength.

In step S330 of FIG. 3, the AP 105 determines whether the connection strength drops below the lower connection strength threshold. If the AP 105 determines that the connection strength with the mobile device 530 remains at least equal to the lower connection strength threshold, the process returns to step S325 and the AP 105 continues to serve (e.g., transfer data to/from) the mobile device. Remaining at or above the lower connection strength threshold implies that the mobile device 530 remains within the entry level boundary region of FIG. 2. Otherwise, if the AP 105 determines that the connection strength of the mobile device 530 drops below the lower connection strength threshold, the process advances to step S335. In step S335, the AP 105 reports the lowered connection status of the mobile device 530 to the MC 125. The reporting of the lowered connection status is treated by the MC 125 as a request to handoff the mobile device 530 to a neighboring AP, the handling of which will be described in greater detail later.

### Call Handoff in the WLAN System

FIG. 4 illustrates a handoff process of a mobile device 530 from the AP 105 to the AP 110 within the WLAN 100 according to an example embodiment of the present invention. FIG. 5 illustrates positions of the mobile device 530 within the WLAN 100 during different steps of the handoff process of FIG. 4.

In the example embodiment of FIG. 4, the mobile device 530 is initially positioned at position P0 of FIG. 5, which is within both the entry and safe level boundary regions of AP 105. The mobile device 530 establishes a connection with the AP 105 using the process described above with respect to FIG. 3. Accordingly, the mobile device 530 sends out a signal to request a connection, and the AP 105 performs steps S300 to S325 to establish the connection. While FIG. 3 is described from the perspective of the AP 105, FIG. 4 illustrates how the MC 125 is affected during steps S310 and S315 of FIG. 3. Thus, in step S310, the AP 105 sends the report to the MC 125 to indicate that the measured signal strength of signals received from the mobile device 530 is above the lower connection strength threshold (e.g., because the mobile device 530 is positioned within the entry level boundary region of the AP 105). In step S400, the MC 125 receives the report sent from the AP 105. In step S405, the MC 125 determines whether or not the mobile device 530 is currently being served by another AP within the WLAN 100. If the MC 125 determines that the mobile device 530 is currently being served by another AP within the WLAN 100, the MC 125 takes no action and no authorization to communicate with the mobile device 530 is granted to the AP 105. Alternatively, if the MC 125 determines that the mobile device 530 is not being served, the MC 125 sends a signal to the AP 105 which authorizes the AP 105 to establish a connection with the mobile device 530. The AP 105 receives the authorization (step S315 of FIG. 3), establishes the connection with the mobile device 530 (step S320 of FIG. 3) and serves (e.g., transfers data to/from) the mobile device 530 (step S325 of FIG. 3).

The AP 105 remains in step S325 and continues to serve the mobile device 530. Referring to FIG. 5, the mobile device 530 remains at position P0 during the above-described call connection setup. However, it is understood that, in other example embodiments, the mobile device 530 could establish a connection with the AP 105 anywhere within the entry level boundary region of the AP 105.

In step S410 of FIG. 4, the mobile device 530 begins moving towards the AP 110 from position P0 of FIG. 5. As shown in FIG. 5, the mobile device 530 moves along the line illustrated in FIG. 5, from position P0 to position P1. In step S415 of FIG. 4, the mobile device 530 reaches position P1 and enters the entry level boundary region of the AP 110. Accordingly, in step S420 of FIG. 4, the AP 110 receives and measures signals transmitted by the mobile device 530 at signal strengths at least equal to the lower connection strength threshold. In step S425, the AP 110 reports that the measured signal strength of the mobile device 530 is at least equal to the lower connection strength threshold to the MC 125.

In step S430, the MC 125 receives the report from the AP 110 and determines whether another AP is serving the mobile device 530. Because the AP 105 is already serving the mobile device 530, the MC 125 determines to take no action and does not authorize the AP 110 to establish a connection with the mobile device 530.

In step S435 of FIG. 4, the mobile device 530 reaches position P2 of FIG. 5. As shown in FIG. 5, at position P2, the mobile device 530 is still within the entry level boundary region of AP 105, but also enters the safe level boundary region of AP 110. Accordingly, in step S440, the AP 110 receives and measures transmissions sent by the mobile device 530 with signal strengths greater than or equal to the higher connection strength threshold. In step S445, the AP 110 reports to the MC 125 that the measured signal strength of signals received from the mobile device 530 are at least equal to the higher connection strength threshold.

In step S450 of FIG. 4, the MC 125 receives the report from the AP 110 (sent at step S445) and adds AP 110 to an active set for the mobile device 530. The active set is a list of APs capable of serving the mobile device 530. The active set is stored and updated at the MC 125 and is used to select alternate serving APs if a handoff becomes necessary, as will be described later in the process of FIG. 4.

In step S455 of FIG. 4, the mobile device 530 reaches position P3 of FIG. 5. As shown in FIG. 5, at position P3, the mobile device 530 is no longer within the entry level boundary region of AP 105, but remains within the safe level boundary region of AP 110. Accordingly, in step S460 of FIG. 4, the AP 105 determines that its connection strength with the mobile device 530 has fallen below the lower connection strength threshold (step S330 of FIG. 3). In step S465 of FIG. 4, the AP 105 reports the lowered connection status between the AP 105 and the mobile device 530 to the MC 125 (step S335 of FIG. 3).

In step S470, the MC 125 receives the lowered connection status report from the AP 105 and analyzes the active set for the mobile device 530 to determine whether another AP is available to serve the mobile device 530. Because the MC 125 added the AP 110 to the mobile device's 530 active set in step S450, the MC 125 determines that a handoff of the mobile device 530 from the AP 105 to the AP 110 is available. Accordingly, in step S475, the MC 125 sends handoff instructions to the AP 105 and the AP 110.

In step S480, the AP 105 receives the handoff instructions from the MC 125 and stops serving, or attempting to serve, the mobile device 530. In step S485, the AP 110 receives the bandoff instructions from the MC 125 and begins serving the mobile device 530.

While not illustrated in FIG. 4, the AP 110 continues to monitor the signal strength of signals received from the mobile device 530 after step S450. If the measured signal strength falls below the higher connection strength threshold, the AP 110 reports the lowered signal strength to the MC 125. The MC 125 then removes AP 110 from the active set of the mobile device 530. Thus, the MC 125 cooperates with the APs 105/110/115 of the WLAN 100 so as to maintain a relatively up-to-date active set.

Further, as will be appreciated with respect to the handoff process of FIG. 4, the mobile device 530 is not aware of the handoff from the AP 105 to the AP 110. Rather, from the perspective of the mobile device 530, once a connection is established, the mobile device 530 assumes that its connection remains with the initial serving AP. Thus, legacy mobile devices can be employed within the WLAN system 100 and may receive the benefits of the above-described simplified handoff process.

### Interference Reduction in the WLAN System

As discussed above, each AP within the WLAN system 100 of FIG. 1 is configured to transmit on the same channel, whereas conventional WLAN systems typically include neighboring or adjacent APs transmitting on different channels to reduce outer-cell interference. Accordingly, the same-channel transmissions of the APs within the WLAN system 100 may cause increased system interference.

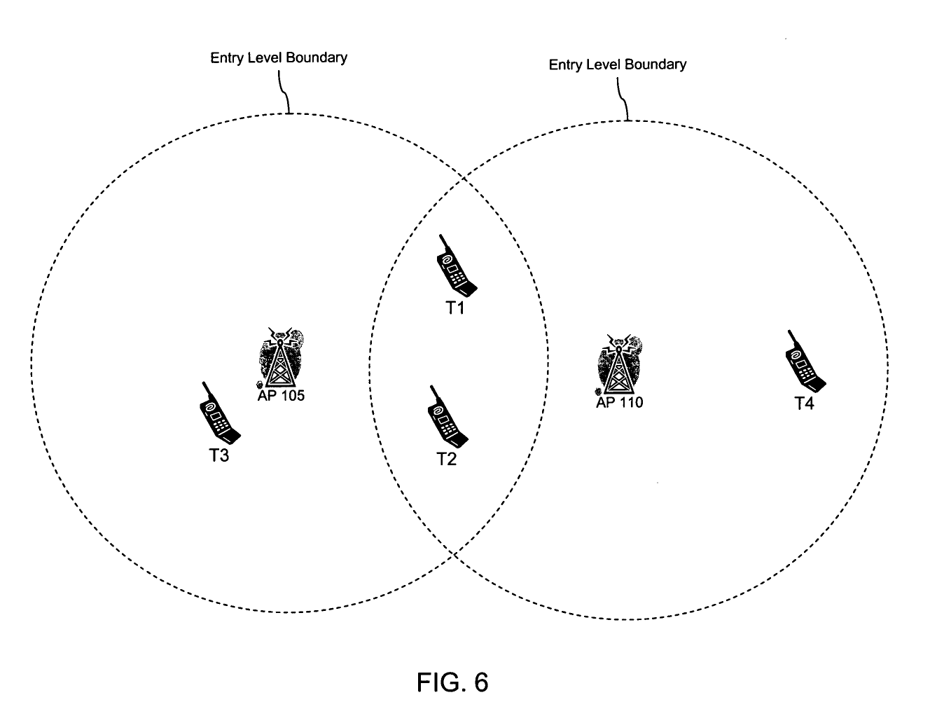

In order to reduce interference within the WLAN system 100, the MC 125 configures the APs within the WLAN system 100, as well as corresponding served mobile devices 530, to use time division in accordance with a point coordination function (PCF) mode. The PCF mode is a well-known polling protocol which partitions potential interferers into different time slots. Thus, the MC 125 configures each of its APs to poll potentially intersecting or interfering mobile devices during different time slots. The time slot partitioning of communication within the WLAN system 100 will now be described with respect to FIG. 6.

FIG. 6 illustrates a portion of the WLAN system 100 including APs 105 and 110 and mobile devices T1 through T4 according to another example embodiment of the present invention.

In the example embodiment of FIG. 6, the entry level boundary regions for APs 105 and 110 intersect. Mobile device T3 is positioned within a non-intersecting portion of the entry level boundary region for AP 105, mobile device T4 is positioned within a non-intersecting portion of the entry level boundary region for AP 110, and mobile devices T1 and T2 are positioned within an intersecting portion of the entry level boundary regions for AP 105 and AP 110.

Table 1 (below) illustrates an example polling schedule for the mobile terminals T1 through T4.

TABLE 1

| Time slot | AP 105 | AP 110 |
|---|---|---|
| Time slot 1 | Poll T1 | Standby (idle) |
| Time slot 2 | Standby (idle) | Poll T2 |
| Time slot 3 | Poll T3 | Poll T4 |

As shown in Table 1, the example polling schedule includes three (3) time slots. The three time slots repeat in succession such that each mobile device is polled and can access its serving AP at a given interval (e.g., at every third time slot). In time slot 1, mobile device T1 is polled by AP 105 while AP 110 is in “standby” mode. Because mobile device T1 is in the intersecting portion of the entry level boundary regions for AP 105 and AP 110, when the mobile device T1 is polled, the AP 110 cannot poll mobile devices without interfering with the polling of the mobile device T1. Accordingly, AP 110 remains in standby during time slot 1. In time slot 2, AP 105 remains in standby while AP 110 polls mobile device T2. In time slot 3, AP 105 polls mobile device T3 and AP 110 polls mobile device T4. Both mobile devices T3 and T4 are capable of simultaneous polling in time slot 3 because they are each positioned in non-intersecting portions of the entry level boundary regions of AP 105 and AP 110, respectively. In other words, because mobile devices T3 and T4 are non-intersecting, the mobile devices 13 and T4 can be simultaneously polled without interfering with each other. Simultaneous polling of non-intersecting mobile devices is desirable to reduce the number of required time slots.

Generally, in order to increase the bandwidth used by the WLAN system 100 and to reduce “standby” or idle times, the fewest number of time slots for the polling schedule (e.g., of Table 1) should be used. Accordingly, Table 1 represents an example polling schedule with only three (3) time slots. However, it is understood that other variations of polling schedules may be achieved, and Table 1 merely illustrates an example polling schedule to explain the concept of reducing interference with time division in PCF mode while maintaining a highest possible bandwidth usage.

Example embodiments of the present invention being thus described, it will be obvious that the same may be varied in many ways. For example, while generally above-described with respect to 802.11 WLANs, it is understood that other example embodiments of the present invention may be applied to WLANs operating in accordance with any wireless communication protocol (e.g., Bluetooth, 802.16, etc.). Such variations are not to be regarded as a departure from the spirit and scope of the exemplary embodiments of the invention, and all such modifications as would be obvious to one skilled in the art are intended to be included within the scope of the invention.

We claim:

1. A method of managing access points in a wireless local area network (WLAN) operating in accordance with a wireless communication protocol, comprising:
managing which of a plurality of access points in the wireless local area network handles communication with a wireless station, each of the plurality of access points being assigned a same communication frequency range and same identifying information for communication with wireless stations.

2. The method of claim 1, wherein the communication frequency range and identifying information are assigned such that a wireless station cannot distinguish between the plurality of access points.

3. The method of claim 1, wherein the identifying information includes one or more of a machine access code (MAC) address and at least one basic service set identifier (BSSID).

4. The method of claim 1, wherein the managing step manages set up of communication between a wireless station and one of the plurality of access points based on at least one signal strength measurement report received from the access point, the signal strength measurement report indicating a signal strength of a transmission received at the access point from the wireless station.

5. The method of claim 4, wherein the managing set up step comprises:
determining whether to authorize the access point sending the signal strength measurement report to handle communication with the wireless station based on the signal strength measurement report.

6. The method of claim 5, wherein the determining step determines to authorize the access point if the signal strength indicated in the signal strength measurement report exceeds a first threshold and another of the plurality of access points is not currently handling communication with the wireless station.

7. The method of claim 5, wherein the managing set up step further comprises:
sending an instruction to the access point indicating that the access point is authorized to handle communication with the wireless station if the determining step determines that the access point is authorized to handle communication with the wireless station.

8. The method of claim 6, wherein the wireless station is a mobile wireless station.

9. The method of claim 8, wherein the managing step manages handoff of the mobile wireless station from a current serving access point to another of the plurality of access points based on signal strength measurement reports received from more than one access point, each signal strength measurement report indicating a signal strength status of a received transmission from a mobile wireless station at the access point associated with the signal strength measurement report.

10. The method of claim 9, wherein the managing handoff step comprises:
maintaining an active set of access points other than the current serving access point such that each access point in the active set has sent a signal strength measurement report indicating a received signal strength greater than the first threshold; and
determining to handoff the mobile wireless station from the current serving access point to one of the access points in the active set if a signal strength status reported from the current serving access point in a signal strength measurement report indicates a received signal strength below a second threshold, the second threshold being less than the first threshold.

11. The method of claim 10, wherein the second threshold corresponds to a minimum signal strength sufficient to maintain a connection between the current serving access point and the mobile wireless station.

12. The method of claim 10, wherein the maintaining step includes:
receiving another signal strength measurement report; and
adding the access point to the active set if the received another signal strength measurement report is received from an access point, other than the serving access point and not allocated to the active set, indicating a received signal strength greater than the first threshold.

13. The method of claim 10, wherein the maintaining step includes:
receiving another signal strength measurement report from an access point within the active set; and
removing the access point from the active set if the received another signal strength measurement report indicates a received signal strength below the first threshold.

14. The method of claim 10, wherein the managing handoff step further comprises:
selecting one of the access points from the active set;
sending a first instruction to the selected access point instructing the selected access point to begin serving the mobile device; and
sending a second instruction to the current serving access point instructing the first access point to stop serving the mobile device.

15. The method of claim 1, wherein the wireless station is a mobile wireless station.

16. The method of claim 15, wherein the managing step manages handoff of the mobile wireless station from a current serving access point to another of the plurality of access points based on signal strength measurement reports received from more than one access point, each signal strength measurement report indicating a signal strength status of a received transmission from a mobile wireless station at the access point associated with the signal strength measurement report.

17. The method of claim 16, wherein the managing handoff step comprises:
maintaining an active set of access points other than the current serving access point such that each access point in the active set has sent a signal strength measurement report indicating a received signal strength greater than the first threshold; and
determining to handoff the mobile wireless station from the current serving access point to one of the access points in the active set if a signal strength status reported from the current serving access point in a signal strength measurement report indicates a received signal strength below a second threshold, the second threshold being less than the first threshold.

18. The method of claim 1, wherein the wireless communication protocol is one of Bluetooth, IEEE 802.11 and IEEE 802.16.

19. A wireless local area network (WLAN) operating in accordance with a wireless communication protocol, comprising:
a plurality of access points configured to communicate with wireless stations, each of the plurality of access points being assigned a same communication frequency range and same identifying information for communication with wireless stations; and
a master controller managing which of the plurality of access points in the wireless local area network handles communication with a wireless station.

20. The WLAN of claim 19, wherein the identifying information includes one or more of a machine access code (MAC) address and at least one basic service set identifier (BSSID).

21. The WLAN of claim 19, the managing step manages set up of communication between a wireless station and one of the plurality of access points based on at least one signal strength measurement report received from the access point, the signal strength measurement report indicating a signal strength of a transmission received at the access point from the wireless station.

22. The WLAN of claim 19, wherein the master controller manages handoff of a mobile wireless station from a first the plurality of access points to a second of the plurality of access points based on signal strength measurement reports received from more than one access point, each signal strength measurement report indicating a signal strength status of a received transmission from a mobile wireless station at the access point associated with the signal strength measurement report.

23. The WLAN of claim 19, wherein the master controller performs the handoff management by:
maintaining an active set of access points, a first signal strength measurement report indicating a received signal strength greater than a first threshold having been received from each access point in the active set; and
determining to handoff the mobile wireless station from a current serving access point to one of the access points in the active set if a signal strength status reported from the current serving access point in a second signal strength measurement report indicates a received signal strength below a second threshold, the second threshold being less than the first threshold.
